(19) United States
(12) Patent Application Publication
(10) Pub. No.: US 2026/0125247 A1
(43) Pub. Date: May 7, 2026

(54) OVERHEAD HOIST TRANSPORT DEVICE AND OPERATION METHOD OF THE SAME

(71) Applicant: NANYA TECHNOLOGY CORPORATION, New Taipei City (TW)

(72) Inventors: Hung Hsiang HU, New Taipei City (TW); Zheng-Xun YANG, New Taipei City (TW)

(21) Appl. No.: 18/936,968

(22) Filed: Nov. 4, 2024

(51) Int. Cl. B66C 15/04; B66C 19/00

(52) U.S. Cl. CPC B66C 15/045; B66C 19/00

(57) ABSTRACT

An operation method of the overhead hoist transport device includes acquiring a first image of a first car by an image acquisition device on a second car; calculating a regression distance between the first car and the second car by using the first image as an input of a CNN model; adjusting a real distance between the first car and the second car based on the regression distance; and performing a CNN regression to adjusting a focus of the image acquisition device on the second car based on the regression distance.

### FIELD OF INVENTION

The present invention relates to an overhead hoist transport device and an operation method of the overhead hoist transport device.

### DESCRIPTION OF RELATED ART

In the overhead hoist transport field, a linear distance sensor and a curve distance sensor are commonly used. However, such sensor can only detect the distance between adjacent two cars only when the cars move along a linear track or a curved track with an angle within a detectable range of the curve distance sensor. Therefore, when the angle difference between the traveling directions of the adjacent two cars is not within the detectable range of the curve distance sensor, the distance between the cars cannot be detected.

Accordingly, it is still a development direction for the industry to provide a operation method of the overhead hoist transport device that can solve the problem described above.

### SUMMARY

The invention provides an operation method of the overhead hoist transport device. The overhead hoist transport includes at least a first car and a second car.

In one embodiment, the operation method of the overhead hoist transport device includes acquiring a first image of a first car by an image acquisition device on a second car; calculating a regression distance between the first car and the second car by using the first image as an input of a CNN model; adjusting a real distance between the first car and the second car based on the regression distance; and performing a CNN regression to adjusting a focus of the image acquisition device on the second car based on the regression distance.

In one embodiment, the operation method of the overhead hoist transport device further includes obtaining an image data of the first car by multiple cameras on the second car and obtaining a distance data between the first car and the second car by a distance sensor module on the second car before acquiring the first image of the first car by the image acquisition device on the second car; and training a CNN model based on the distance data and the image data.

In one embodiment, the distance sensor module comprises a linear distance sensor and a curve distance sensor, and obtaining the image data of the first car by the cameras on the second car and obtaining the distance data between the first car and the second car by the distance sensor module on the second car further includes sensing a linear distance between the first car and a second car by the linear distance sensor on the second car when the first car and the second car move in a linear section of a track; and sensing a curved distance between the first car and a second car by the curve distance sensor on the second car when the first car and the second car move in a curved section of a track.

In one embodiment, the operation method of the overhead hoist transport device further includes calculating a detected distance between the first car and the second car by using the distance sensor module; and comparing the regression distance and the detected distance to determine a minimum value.

In one embodiment, adjusting the real distance between the first car and the second car based on the regression distance further includes adjusting the real distance between the first car and the second car based on the minimum value.

In one embodiment, performing the CNN regression to adjusting the focus of the image acquisition device on the second car based on the regression distance further includes performing CNN regression to adjusting the focus of the image acquisition device on the second car based on the minimum value.

In one embodiment, obtaining the image data of the first car by the cameras on the second car and obtaining the distance data between the first car and the second car by the distance sensor module on the second car further includes acquiring multiple test images of the first car by each one of the cameras on the first car, wherein the test images are acquired with different focal length.

In one embodiment, calculating the regression distance between the first car and the second car by using the CNN model further includes transmitting the regression distance to the controlling system by the micro-controller of the image acquisition device after receiving a first signal sent by the controlling system.

In one embodiment, a first time rate of calculating the regression distance is different from a second time rate of sending the first signal to the micro-controller.

In one embodiment, the operation method of the overhead hoist transport device further includes sending an emergency signal to the controlling system of the overhead hoist transport device by the micro-controller of the image acquisition device when the regression distance is smaller than a threshold.

In one embodiment, the operation method of the overhead hoist transport device further includes enhancing the test images; comparing the test images after enhancement to get a comparing result; and determining one of the cameras as the first image acquisition device based on the comparing result.

The invention provides an overhead hoist transport device.

In one embodiment, the overhead hoist transport device includes a first car and a second car. The first car and the second car each include a controlling system, an image acquisition device includes a micro-controller, and the image acquisition device is electrically connected with the controlling system.

In one embodiment, the distance sensor module includes a linear distance sensor and a curve distance sensor electrically connected with the linear distance sensor.

In one embodiment, the first car and the second car each include a first part having a front side and a second part having a front side. The curve distance sensor is disposed on the first part. The linear distance sensor is disposed on the second part.

In one embodiment, the overhead hoist transport device further includes a first reflective mirror disposed on the first part.

In one embodiment, the overhead hoist transport device further includes a second reflective mirror disposed on the second part.

In one embodiment, the overhead hoist transport device further includes multiple cameras disposed at different positions on the front side of the first car and the front side of the second car.

In the aforementioned embodiments, the image acquisition device on the second car is used to acquire an image of the first car. The image of the first car is used as an input of the CNN model. A distance between the first car and the second car at the time point when the image is acquired can be obtain through the CNN regression. Accordingly, the distance between first car and the second car regardless of traveling direction can be detected through the CNN regression or a combination of the CNN regression and the distance sensor module. Therefore, the operation method by using the CNN regression can be applied for any type of track and configuration of cars as long as the CNN model is trained by using the test images.

### BRIEF DESCRIPTION OF THE DRAWINGS

The invention can be more fully understood by reading the following detailed description of the embodiment, with reference made to the accompanying drawings as follows:

FIG. 1 is a side view of an overhead hoist transport device according to one embodiment of the present disclosure.

FIG. 2 is a front view of the overhead hoist transport device in FIG. 1.

FIG. 3 is a back view of the overhead hoist transport device in FIG. 1.

FIG. 4 is a side view of a first car and a second car of the overhead hoist transport device according to one embodiment of the present disclosure.

FIG. 5 is a top view of FIG. 4.

FIG. 6 is a top view of a first car and a second car of an overhead hoist transport device according to one embodiment of the present disclosure.

FIG. 7 is a flow chart of an operation method of the overhead hoist transport device in FIG. 1 according to one embodiment of the present closure.

FIG. 8 is a schematic of a test image of the first car according to one embodiment.

FIG. 9 is a flow chart of another operation method of the overhead hoist transport device in FIG. 1according to one embodiment of the present closure.

FIG. 10 is a flow chart of another operation method of the overhead hoist transport device in FIG. 1according to one embodiment of the present closure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

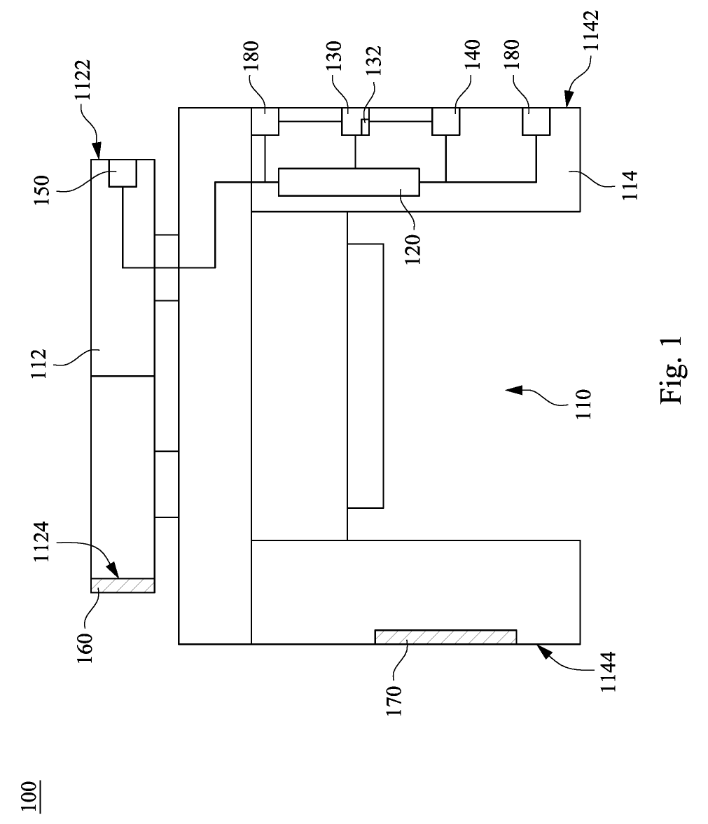

FIG. 1 is a side view of an overhead hoist transport (OHT) device 100 according to one embodiment of the present disclosure. The overhead hoist transport device includes at least a car 110, a controlling system 120, an image acquisition device 130, a linear distance sensor 140, and a curve distance sensor. The controlling system 120 is electrically connected with the image acquisition device 130, the linear distance sensor 140, and the curve distance sensor 150. The image acquisition device 130 includes a micro-controller 132 configured to train a CNN (Convolutional Neural Network) model based on an image data and perform a CNN regression.

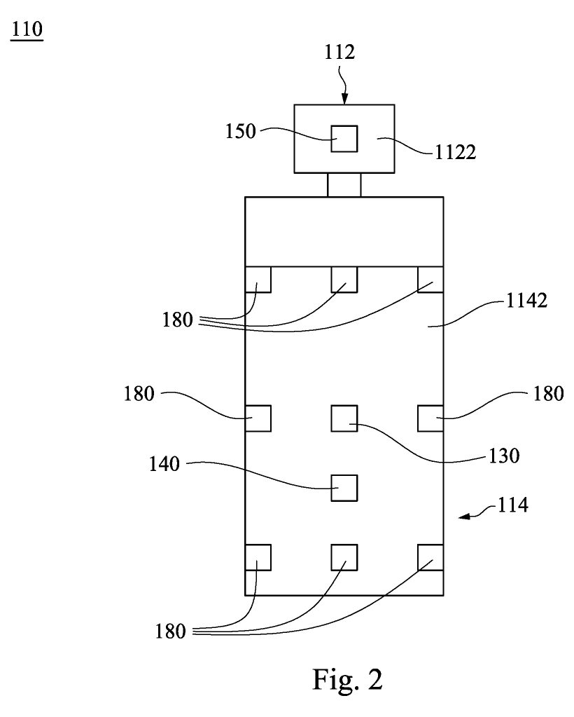

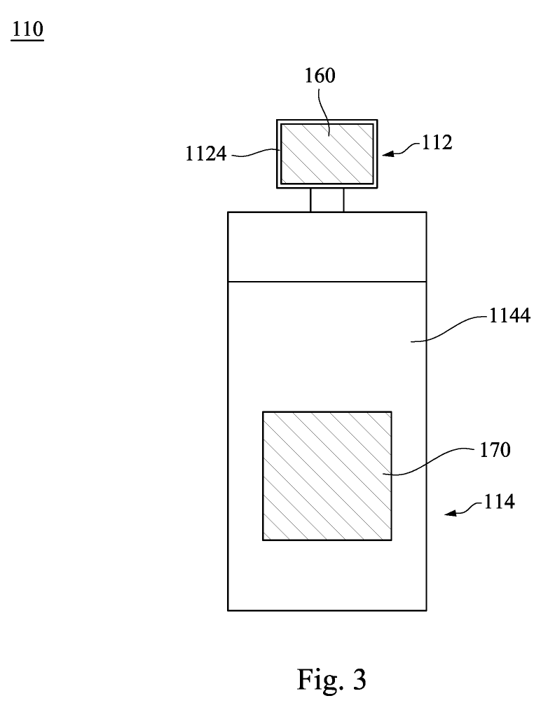

FIG. 2 is a front view of the car 110 of the overhead hoist transport device 100 in FIG. 1. The controlling system 120 is omitted in FIG. 2 and FIG. 3. Reference is made to FIG. 1 and FIG. 2. The car 110 includes a first part 112 and a second part 114. The first part 112 is an upper part of the car 110, and the second part 114 is the lower part of the car 110. The first part 112 of the car 110 includes a front side 1122 and a back side 1124. The second part 114 of the car 110 includes a front side 1142 and a back side 1144. The linear distance sensor 140 is disposed on front side 1142 of the second part 114. The curve distance sensor 150 is disposed on the front side 1122 of the first part 112.

FIG. 3 is a back view of the car 110 of the overhead hoist transport device 100 in FIG. 1. Reference is made to FIG. 1 and FIG. 3. The overhead hoist transport device 100 further includes a first reflective mirror 160 and a second reflective mirror 170. The first reflective mirror 160 is disposed on back side 1124 of the first part 112 of the car 110. The second reflective mirror 170 is disposed on the back side 1144 of the second part 114 of the car 110.

As shown in FIG. 2, the overhead hoist transport device 100 further includes multiple cameras 180 disposed on the front side 1142 of the second part 114. The cameras 180 are positioned at different positions on the front side 1142 of the first car 110A and the second car 110B. In this embodiment, the cameras 180 and the image acquisition device 130 both can be used to acquire images of another car 110. Alternatively speaking, the image acquisition device 130 is one of the cameras 180. Those images are used to train a CNN model. The image acquisition device 130 is the specific one of the cameras 180 that can obtain best quality image for the CNN model, and therefore the image acquisition device 130 is used to perform image acquisition during the process of CNN regression. The operation method will be described in the following paragraphs.

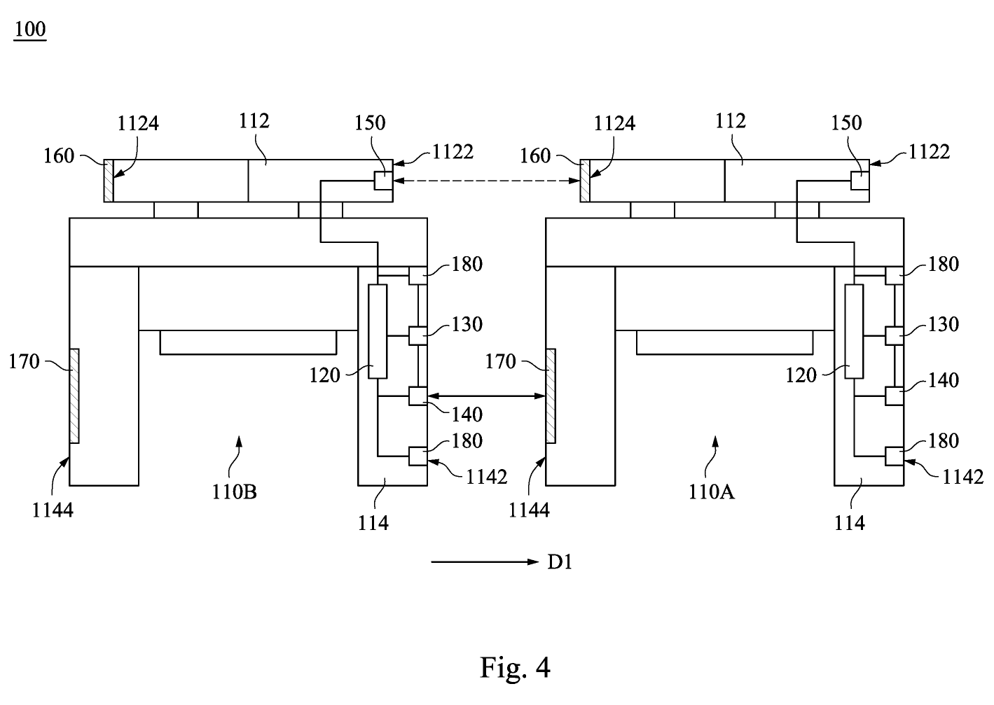

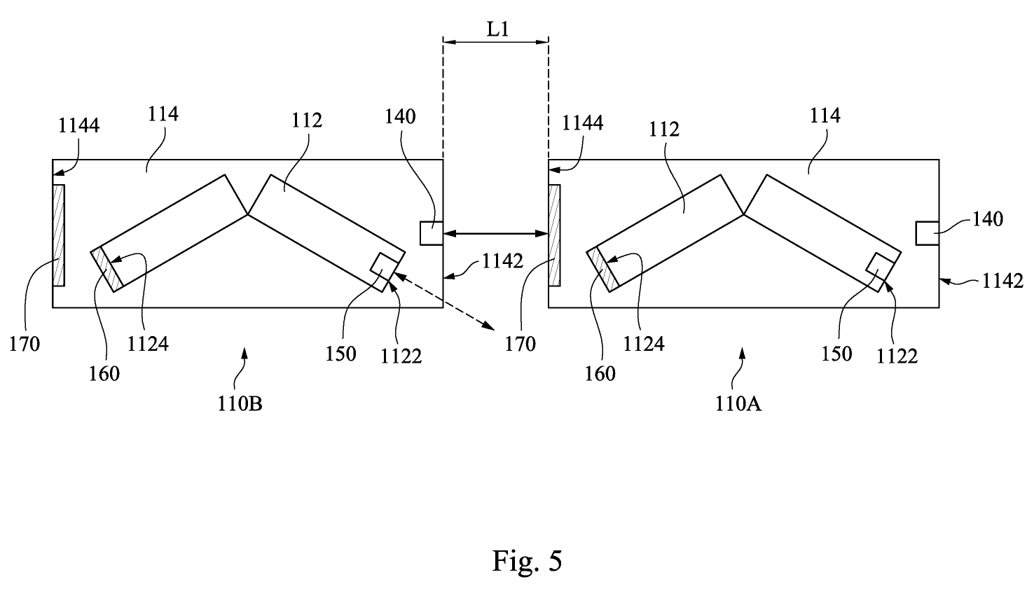

FIG. 4 is a side view of a first car 110A and a second car 110B of the overhead hoist transport device 100 according to one embodiment of the present disclosure. FIG. 5 is a top view of FIG. 4. The controlling system 120, the image acquisition device 130, and the cameras 180 are omitted in FIG. 5. The overhead hoist transport device 100 includes multiple cars, and each one of the cars has the same configurations shown in FIG. 1. FIG. 4 and FIG. 5 illustrate the relative positions between the first car 110A and the second car 110B when the first car 110A and the second car 110B move in a linear section of a track. The first direction D1 represents the traveling direction of the first car 110A and the second car 110B.

Reference is made to FIG. 5. The first part 112 and the second part 114 can be relatively rotated. When the first car 110A and the second car 110B move along the first direction D1, the front side 1142 of the second part 114 of the second car 110B directly faces the back side 1144 of the second part 114 of the first car 110A. Therefore, the linear distance sensor 140 of the second car 110B directly faces the second reflective mirror 170 of the first car 110A. The linear distance sensor 140 of the second car 110B receives reflected light beam from the second reflective mirror 170 of the first car 110A to detect the distance L1 between the first car 110A and the second car 110B.

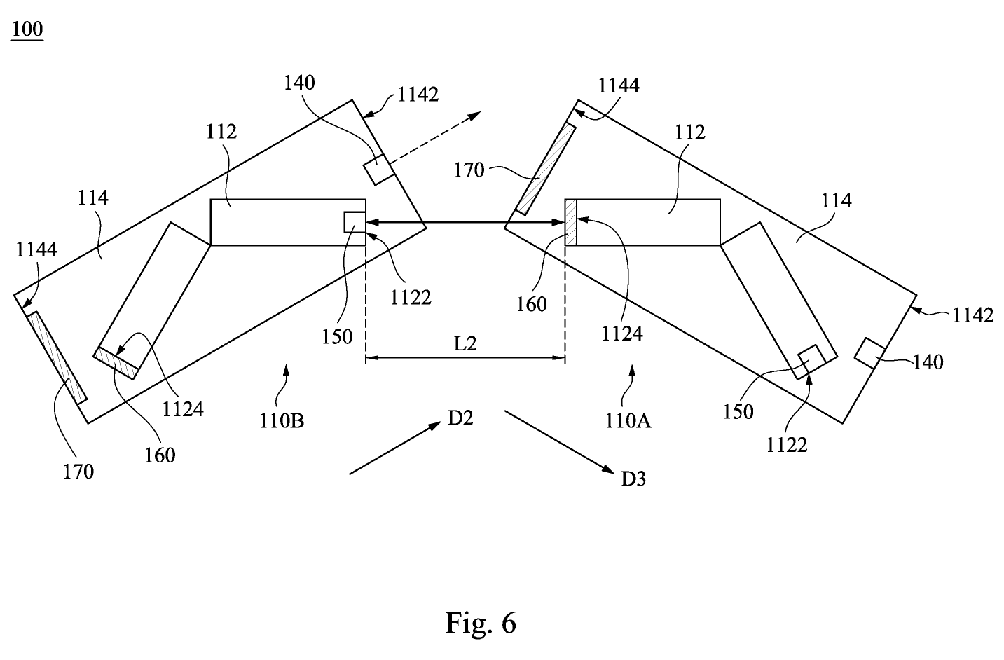

FIG. 6 is a top view of a first car 110A and a second car 110B of the overhead hoist transport device 100 according to one embodiment of the present disclosure. FIG. 6 illustrates the relative positions between the first car 110A and the second car 110B when the first car 110A and the second car 110B move in a curved section of a track. The first direction D2 represents the traveling direction of the second car 110B, and the third direction D3 represents the traveling direction of the first car 110A. The front side 1142 of the second part 114 of the second car 110B does not face the back side 1144 of the second part 114 of the first car 110A. Therefore, the linear distance sensor 140 of the second car 110B does not face the second reflective mirror 170 of the first car 110A. In such condition, the front side 1122 of the first part 112 of the second car 110B may face the back side 1124 of the first part of the first car 110A, but the present disclosure is not limited thereto. Specifically, the first part 112 rotates when the first car 110A and the second car 110B move in a curved section of a track. The curve distance sensor 150 of the first car 110A can receive reflected light beam from the first reflective mirror 160 of the second car 110B to detect the distance L2 between the first car 110A and the second car 110B when an angle difference between the second direction D2 and the third direction D3 is within a detectable range of the curve distance sensor 150.

As described above, the linear distance sensor 140 and the curve distance sensor 150 is a distance sensor module. However, the distance sensor module can detect the distance between the first car 110A and the second car 110B only when the first car 110A and the second car 110B move along a linear track or along a curved track with an angle within the detectable range of the curve distance sensor 150. That is, when the angle difference between the second direction D2 and the third direction D3 is not within the detectable range of the curve distance sensor 150, the distance between the first car 110A and the second car 110B cannot be detected.

Therefore, the image acquisition device 130 on the second car 110B is used to acquire an image of the first car 110A. The image of the first car 110A is used as an input of the CNN model. A distance between the first car 110A and the second car 110B at the time point when the image is acquired can be obtain through the CNN regression. Accordingly, the distance between first car 110A and the second car 110B regardless of traveling direction can be detected through the CNN regression or a combination of the CNN regression and the distance sensor module.

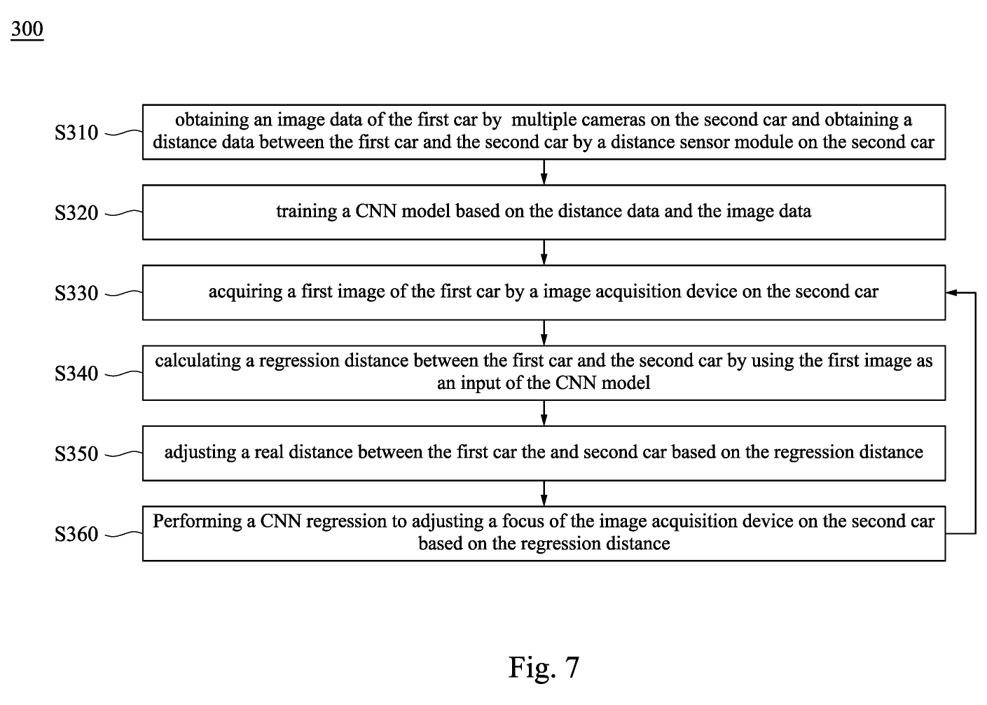

FIG. 7 is a flow chart of an operation method 300 of the overhead hoist transport device 100 in FIG. 1 according to one embodiment of the present closure. The operation method 300 in the present embodiment uses the CNN regression to detect and adjust the distance between the cars 110 of the overhead hoist transport device 100.

Reference is made to FIG. 4 and FIG. 7. The operation method 300 begins with step S310, which is obtaining an image data of the first car 110A by multiple cameras 180 on the second car 110B and obtaining distance data between the first car 110A and the second car 110B by the distance sensor module on the second car 110B. The distance sensor module includes the linear distance sensor 140 and the curve distance sensor 150.

In step S310, the image data is obtained by acquiring multiple test images of the first car 110A by each one of the cameras 180 on the second car 110B. The test images are acquired with different focal length of the cameras 180. The distance data is obtained by the linear distance sensor 140 and the curve distance sensor 150 as described above.

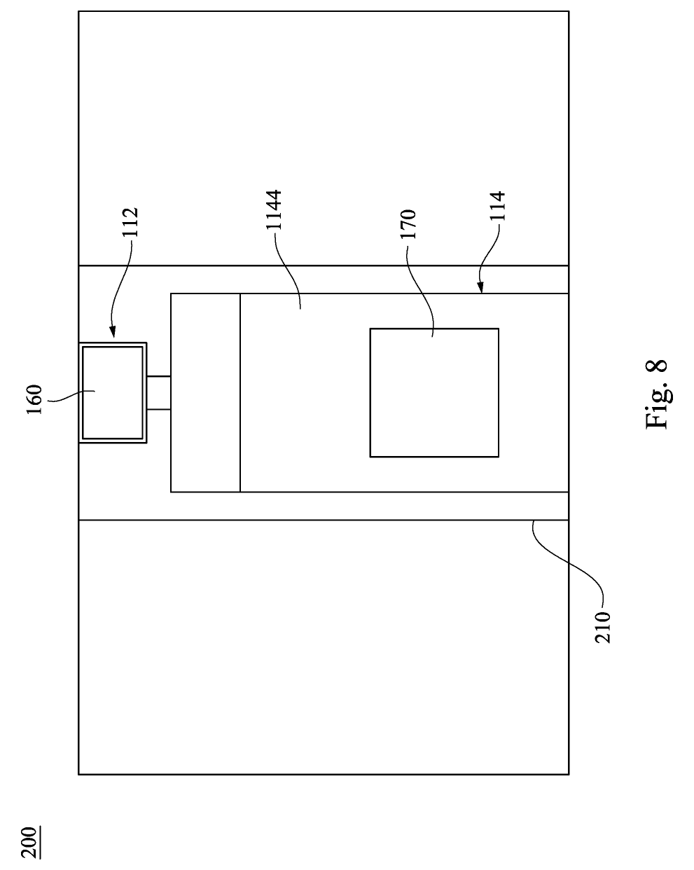

The operation method 300 continues to step S320, a CNN model is trained based on the distance data and the image data. A label data of the CNN model is the correlation between the image data and the corresponding distance data. The test images are used as training data for the CNN model. The test images are processed through image enhancement such as feature detecting, noise detecting, and sharpening processes. FIG. 8 is a schematic of a test image 200 of the first car 110A according to one embodiment. The test image 200 contains the image of the first car 110A. The weight of the kernel corresponding to a feature region 210 is greater so as to improve the feature detecting result.

After image process, a quality of those processed test images are compared to get a comparing result. The comparing test determines a best quality test image, and the camera 180 which used to acquire this best quality test image is selected as the image acquisition device 130 in the following steps.

The operation method continues to step S330, a first image of the first car 110A is acquired by the image acquisition device 130 on the second car 110B. The first image of the first car 110A is acquired at time point 1. In the present embodiment, the traveling direction of the first car 110A and the second car 110B are arbitrary.

The operation method continues to step S340, a regression distance L1 between the first car 110A and the second car 110B is calculated by using the first image as an input of the CNN model. The trained CNN model provides the regression distance L1 as the output. The regression distance L1 recorded in the micro-controller 132 at a time point 2.

The operation method continues to step S350, the operation method 300 continues to adjusting a real distance between the first car 110A and the second car 110B based on the regression distance. In step S350, the controlling system 120 sends a first signal to the micro-controller 132 of the image acquisition device 130 at time point 3, and the micro-controller 132 transmits the regression distance L1 recorded at the time point 2 to the controlling system 120. The controlling system 120 adjusts the speed of the second car 110B to adjust the real distance. As such, the distance between the first car 110A and the second car 110B can be adjusted to a preferred distance that can guarantee safety of the cars 110.

The CNN regression is processed by the micro-controller 132 with a first time rate. That is, the regression distance value is updated after a period of time. For example, the first time rate is about 40 milliseconds. The controlling system 120 sends the first signal with a second time rate. For example, the second time rate is about 10 milliseconds. Therefore, the first time rate of calculating the regression distance is different from a second time rate of receiving the regression distance. In addition, operations of the micro-controller 132 and the controlling system 120 are not synchronized. Alternatively speaking, the operation of the micro-controller 132 is independent from the operation of the controlling system 120. Whenever the real distance is required to be adjusted, the newly updated value of the regression distance is accessed.

The operation method continues to step S360, the operation method 300 continues to performing a CNN regression to adjusting a focus of the image acquisition device 130 on the second car 110B based on the regression distance. After the controlling system 120 adjusts the real distance between the first car 110A and the second car 110B, the controlling system 120 sends a second signal to the micro-controller 132 to adjust the focus of the image acquisition device 130. The focal length is updated such that the image acquisition device 130 can be maintained at the condition which can acquire a higher quality image. The controlling system 120 sends the second signal with a third time rate. The third time rate can be different from the first time rate and the second time rate. Whenever the focus is required to be adjusted, the newly updated value of the regression distance is accessed.

Step S330 to step S360 are repeated during the operation period of the overhead hoist transport device 100. The operation method 300 can be performed regardless of the movement directions of the first car 110A and the second car 110B. Therefore, the operation method 300 by using the CNN regression can be applied for any type of track and configuration of cars 110 as long as the CNN model is trained by using the test images.

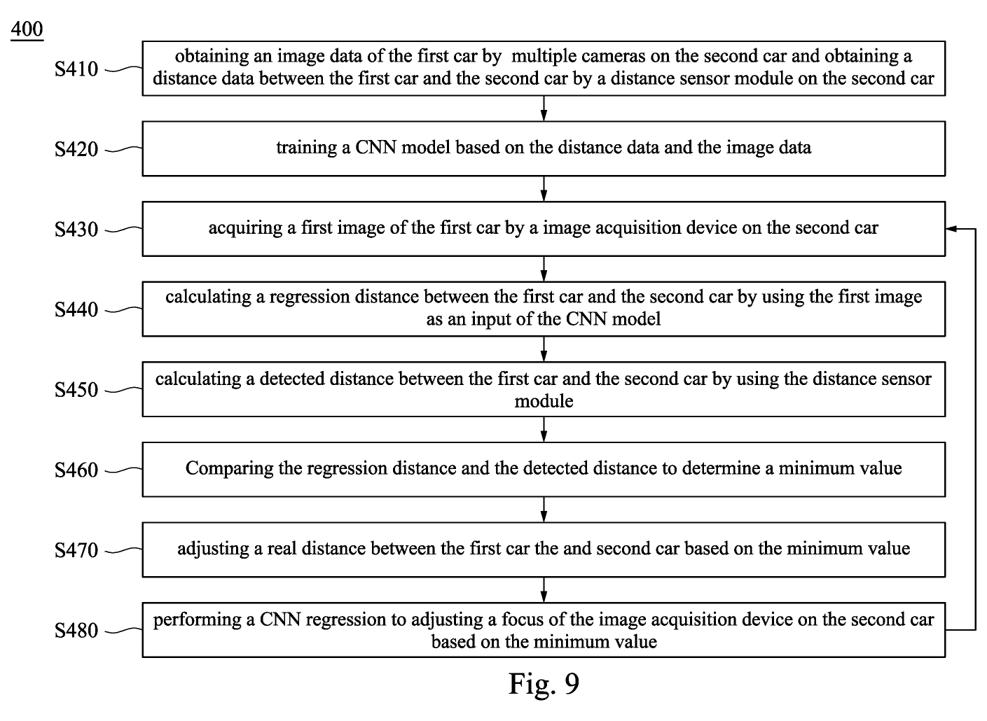

FIG. 9 is a flow chart of another operation method 400 of the overhead hoist transport device 100 in FIG. 1 according to one embodiment of the present closure. The step 410 to step 440 of the operation method 400 are substantially the same as the step 310 to step 340 of the operation method 300.

In step 450 of the operation method 400, a detected distance between the first car 110A and the second car 110B is calculated by using the distance sensor module as described. The detected distance can be calculated by the distance sensor module except for the condition when the angle difference between the traveling directions is not within the detectable range of the curve distance sensor 150.

In step 460 of the operation method 400, the regression distance and the detected distance are compared, and a minimum value is determined. Specifically, a shorter distance represents a higher possibility for the second car 110B to collide with the first car 110A. Therefore, it is more reliable to use a minimum value between the regression distance and the detected distance as the criteria to adjust the real distance.

The CNN regression is processed by the micro-controller 132 with a first time rate. That is, the regression distance value is updated after a period of time. For example, the first time rate is about 40 milliseconds. The distance sensor module has a fourth time rate, and therefore the detected distance value is update after a period of time. For example, the fourth time rate is about 10 milliseconds. Therefore, the first time rate of calculating the regression distance is different from a fourth time rate of calculating the detected distance. In other words, operations of the micro-controller 132 and the controlling system 120 are not synchronized. Alternatively speaking, the operation of the micro-controller 132 is independent from the operation of the controlling system 120.

In step 470 of the operation method 400, the real distance between the first car 110A and the second car 110B is adjusted based on the minimum value. The controlling system 120 sends a first signal to the micro-controller 132 of the image acquisition device 130, and the micro-controller 132 transmits the minimum value to the controlling system 120. The controlling system 120 adjusts the speed of the first car 110A to adjust the real distance. As such, the distance between the first car 110A and the second car 110B can be adjusted to a preferred distance that can guarantee safety of the cars 110.

In step S480 of the operation method 400, the CNN regression is performed to adjust the focus of the image acquisition device 130 based on the regression value. The focal length is updated such that the image acquisition device 130 can be maintained at the condition which can acquire a higher quality image.

After the controlling system 120 adjusts the real distance between the first car 110A and the second car 110B, the controlling system 120 may send a second signal to the micro-controller 132 to adjust the focus of the image acquisition device 130. The focal length is updated as the value of the newly accessed regression distance such that the image acquisition device 130 can be maintained at the condition which can acquire a higher quality image.

Step S430 to step S480 are repeated during the operation period of the overhead hoist transport device. The operation method 300 can be performed regardless of the movement directions of the first car 110A and the second car 110B. Therefore, the operation method 300 by using the CNN regression can be applied for any type of track and configuration of cars 110 as long as the CNN model is trained by using the test images.

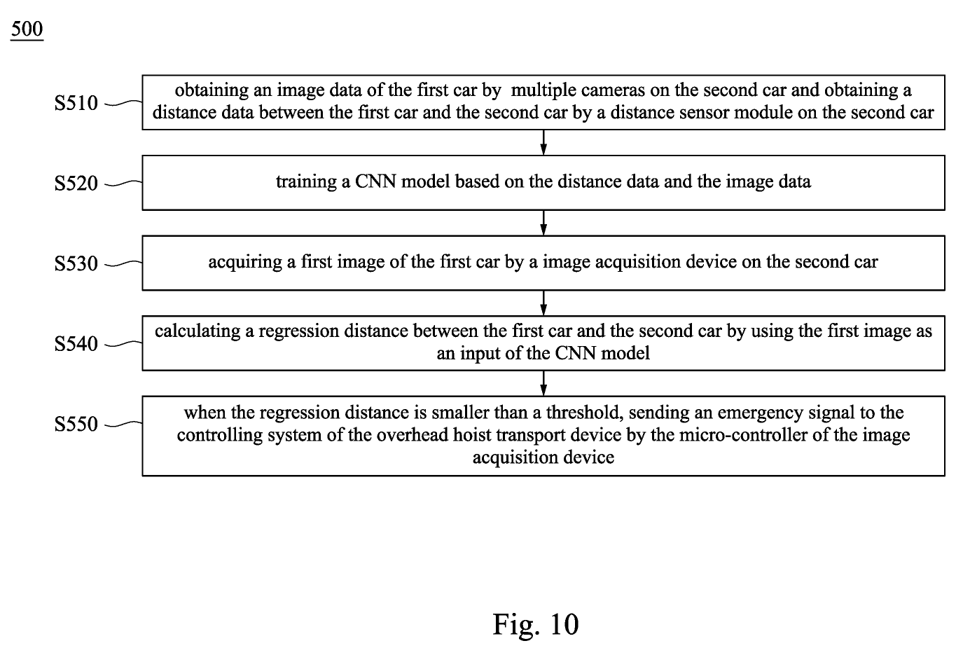

FIG. 10 is a flow chart of another operation method 500 of the overhead hoist transport device 100 in FIG. 1 according to one embodiment of the present closure. The step 510 to step S540 substantially the same as the step 310 to step 340 of the operation method 300. In step S550 of the operation method, the micro-controller 132 of the image acquisition device 130 sends an emergency signal to a controlling system 120 of the overhead hoist transport device 100 when the regression distance is smaller than a threshold. The threshold herein indicates the specific distance when the first car 110A and the second car 110B are considered to be too close. In some embodiments, when the controlling system 120 receives the emergency signal, the first car 110A and the second car 110B may be stopped to avoid collision. In some embodiments, the speed of the first car 110A and the speed of the second car 110B are adjusted so as to make sure that the distance therebetween at least higher than the threshold. In some embodiments, the step S550 of the operation method 500 can be applied in the operation method 300 shown in FIG. 7 and the operation method 400 shown in FIG. 9.

In summary, the image acquisition device on the second car is used to acquire an image of the first car. The image of the first car is used as an input of the CNN model. A distance between the first car and the second car at the time point when the image is acquired can be obtain through the CNN regression. Accordingly, the distance between first car and the second car regardless of traveling direction can be detected through the CNN regression or a combination of the CNN regression and the distance sensor module. Therefore, the operation method by using the CNN regression can be applied for any type of track and configuration of cars as long as the CNN model is trained by using the test images. In some embodiments, a minimum value between the regression distance provided by the image acquisition device and the detected distance provided by the distance sensor module is used as the criteria to improve the reliability of the operation method. In some embodiments, an emergency signal is sent to the controlling system to avoid collision.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An operation method of an overhead hoist transport device, wherein the overhead hoist transport comprises at least a first car and a second car, the operation method comprises:
acquiring a first image of a first car by an image acquisition device on a second car;
calculating a regression distance between the first car and the second car by using the first image as an input of a CNN model;
adjusting a real distance between the first car and the second car based on the regression distance; and
performing a CNN regression to adjusting a focus of the image acquisition device on the second car based on the regression distance.

2. The operation method of the overhead hoist transport device of claim 1, further comprising:
before acquiring the first image of the first car by the image acquisition device on the second car, obtaining an image data of the first car by a plurality of cameras on the second car and obtaining a distance data between the first car and the second car by a distance sensor module on the second car; and
training the CNN model based on the distance data and the image data.

3. The operation method of the overhead hoist transport device of claim 2, wherein the distance sensor module comprises a linear distance sensor and a curve distance sensor, and obtaining the image data of the first car by the plurality of cameras on the second car and obtaining the distance data between the first car and the second car by the distance sensor module on the second car further comprises:
when the first car and the second car move in a linear section of a track, sensing a linear distance between the first car and the second car by the linear distance sensor on the second car; and
when the first car and the second car move in a curved section of the track, sensing a curved distance between the first car and the second car by the curve distance sensor on the second car.

4. The operation method of the overhead hoist transport device of claim 3, further comprises:
calculating a detected distance between the first car and the second car by using the distance sensor module; and
comparing the regression distance and the detected distance to determine a minimum value.

5. The operation method of the overhead hoist transport device of claim 4, wherein adjusting the real distance between the first car and the second car based on the regression distance further comprises:
adjusting the real distance between the first car and the second car based on the minimum value.

6. The operation method of the overhead hoist transport device of claim 4, wherein performing the CNN regression to adjusting the focus of the image acquisition device on the second car based on the regression distance further comprises:
performing CNN regression to adjusting the focus of the image acquisition device on the second car based on the minimum value.

7. The operation method of the overhead hoist transport device of claim 2, wherein obtaining the image data of the first car by the plurality of cameras on the second car and obtaining the distance data between the first car and the second car by the distance sensor module on the second car further comprises:
acquiring a plurality of test images of the first car by each one of the plurality of cameras on the first car, wherein the plurality of test images are acquired with different focal length.

8. The operation method of the overhead hoist transport device of claim 2, wherein calculating the regression distance between the first car and the second car by using the CNN model further comprises:
transmitting the regression distance to a controlling system by a micro-controller of the image acquisition device after receiving a first signal sent by the controlling system.

9. The operation method of the overhead hoist transport device of claim 8, wherein a first time rate of calculating the regression distance is different from a second time rate of sending the first signal to the micro-controller.

10. The operation method of the overhead hoist transport device of claim 8, further comprising:
when the regression distance is smaller than a threshold, sending an emergency signal to the controlling system of the overhead hoist transport device by the micro-controller of the image acquisition device.

11. The operation method of the overhead hoist transport device of claim 7, further comprising:
enhancing the plurality of test images;
comparing the plurality of test images after enhancement to get a comparing result; and
determining one of the cameras as a first image acquisition device based on the comparing result.

12. An overhead hoist transport device, comprising:
a first car and a second car each comprising:
a controlling system;
an image acquisition device comprising a micro-controller, wherein the image acquisition device is electrically connected with the controlling system; and
a distance sensor module electrically connected with the controlling system.

13. The overhead hoist transport device of claim 12, wherein the distance sensor module comprises:
a linear distance sensor; and
a curve distance sensor electrically connected with the linear distance sensor.

14. The overhead hoist transport device of claim 13, wherein the first car and the second car each comprises:
a first part comprising a front side, wherein the curve distance sensor is disposed on the first part; and
a second part comprising a front side, wherein the linear distance sensor is disposed on the second part.

15. The overhead hoist transport device of claim 14, further comprising:
a first reflective mirror disposed on the first part.

16. The overhead hoist transport device of claim 14, further comprising:
a second reflective mirror disposed on the second part.

17. The overhead hoist transport device of claim 14, further comprising:
a plurality of cameras disposed at different positions on the front side of the first car and the front side of the second car.
